(19) United States
(12) Patent Application Publication
(10) Pub. No.: US 2024/0369087 A1
(43) Pub. Date: Nov. 7, 2024

(54) PERMANENT METALLIC JOINT AND ASSOCIATED METHOD OF MAKING THE SAME

(71) Applicant: The Boeing Company, Arlington, VA (US)

(72) Inventor: David P. Heck, St. Charles, MO (US)

(21) Appl. No.: 18/312,426

(22) Filed: May 4, 2023

(51) Int. Cl. F16B 5/08; B64F 5/10

(52) U.S. Cl. CPC F16B 5/08; B64F 5/10

(57) ABSTRACT

A permanent metallic joint comprises a first part made from a first metallic material having a first melting temperature. The first part comprises a tab comprising a tab first surface and a tab second surface, opposite the tab first surface. The permanent metallic joint also comprises a support plate forming a butt joint with the tab. The support plate is made from a second metallic material having a second melting temperature less than the first melting temperature. The permanent metallic joint further comprises a second part made from a third metallic material having a third melting temperature less than the first melting temperature. The second part forms an intermetallic bond with the tab first surface, and forms a metallurgical bond with the support plate.

### FIELD

This disclosure relates generally to metallic joints between parts, and more particularly to a permanent metallic joint for joining together parts of an aircraft.

### BACKGROUND

Some conventional joints for joining parts together include fasteners or adhesives. However, conventional joints can be unsuitable for joining together parts in some applications, such as aircraft, due to the presence of high temperatures. For example, fasteners and adhesives cannot withstand high temperatures experienced on some parts of an aircraft, such as the engine nacelle of an aircraft.

Another type of conventional joint is a welded joint, which includes a weldment between joined parts. Welding can create an effective joint in some applications. However, welding parts together can be difficult in small spaces and provides a relatively small bond area between joined parts.

### SUMMARY

The subject matter of the present application has been developed in response to the present state of the art, and in particular, in response to the above and other shortcomings of conventional joints between metallic parts, which have not yet been fully solved by currently available techniques. Accordingly, the subject matter of the present application has been developed to provide a permanent metallic joint, and an associated method of making the same, that overcome at least some of the shortcomings of prior art techniques.

The following is a non-exhaustive list of examples, which may or may not be claimed, of the subject matter, disclosed herein.

Disclosed herein is a permanent metallic joint. The permanent metallic joint comprises a first part made from a first metallic material having a first melting temperature. The first part comprises a tab comprising a tab first surface and a tab second surface, opposite the tab first surface. The permanent metallic joint also comprises a support plate forming a butt joint with the tab. The support plate is made from a second metallic material having a second melting temperature less than the first melting temperature. The permanent metallic joint further comprises a second part made from a third metallic material having a third melting temperature less than the first melting temperature. The second part forms an intermetallic bond with the tab first surface, and forms a metallurgical bond with the support plate. The preceding subject matter of this paragraph characterizes example 1 of the present disclosure.

The tab further comprises a tab third surface and a chamfer. The tab third surface extends from the tab first surface to the chamfer, and the chamfer extends between the tab third surface and the tab second surface, or the tab first surface and the tab second surface converge toward each other. The preceding subject matter of this paragraph characterizes example 2 of the present disclosure, wherein example 2 also includes the subject matter according to example 1, above.

The second part is in intimate contact with the first part such that an interface between the first part and the second part is gapless. The preceding subject matter of this paragraph characterizes example 3 of the present disclosure, wherein example 3 also includes the subject matter according to any of examples 1-2, above.

The second part is a cast part. The preceding subject matter of this paragraph characterizes example 4 of the present disclosure, wherein example 4 also includes the subject matter according to any of examples 1-3, above.

The second part is an additively manufactured part. The preceding subject matter of this paragraph characterizes example 5 of the present disclosure, wherein example 5 also includes the subject matter according to any of examples 1-3, above.

The first metallic material and the third metallic material are different types of metallic material. The second metallic material and the third metallic material are the same type or similar types of metallic material. The preceding subject matter of this paragraph characterizes example 6 of the present disclosure, wherein example 6 also includes the subject matter according to any of examples 1-5, above.

The permanent metallic joint is free of fasteners and adhesives. The preceding subject matter of this paragraph characterizes example 7 of the present disclosure, wherein example 7 also includes the subject matter according to any of examples 1-6, above.

The first part comprises a plurality of tabs spaced apart from each other along a length of the first part. The permanent metallic joint comprises a plurality of support plates spaced apart from each other along a length of the first part. Each one of the plurality of support plates forms a butt joint with a corresponding one of the plurality of tabs. The second part forms an intermetallic bond with the tab first surface and a tab third surface, extending between the tab first surface and the tab second surface, of each one of the plurality of tabs. The second part forms a metallurgical bond with each one of the plurality of support plates. The preceding subject matter of this paragraph characterizes example 8 of the present disclosure, wherein example 8 also includes the subject matter according to any of examples 1-7, above.

The permanent metallic joint prevents movement of the first part relative to the second part in a first direction, a second direction, opposite the first direction, and a third direction, perpendicular to the first direction and the second direction. The permanent metallic joint also enables movement of the first part relative to the second part in a fourth direction opposite the third direction. The preceding subject matter of this paragraph characterizes example 9 of the present disclosure, wherein example 9 also includes the subject matter according to any of examples 1-8, above.

The first part further comprises a second tab comprising a second-tab first surface and a second-tab second surface, opposite the second-tab first surface. The second part forms an intermetallic bond with the second-tab first surface and the second-tab second surface. The preceding subject matter of this paragraph characterizes example 10 of the present disclosure, wherein example 10 also includes the subject matter according to any of examples 1-9, above.

The permanent metallic joint prevents movement of the first part relative to the second part in a first direction, a second direction, opposite the first direction, a third direction, perpendicular to the first direction and the second direction, and a fourth direction, opposite the third direction. The preceding subject matter of this paragraph characterizes example 11 of the present disclosure, wherein example 11 also includes the subject matter according to example 10, above.

The tab further comprises a tab third surface that is perpendicular to the tab first surface and the tab second surface, and extends between the tab first surface and the tab second surface. The tab first surface is parallel to the tab second surface. The preceding subject matter of this paragraph characterizes example 12 of the present disclosure, wherein example 12 also includes the subject matter according to any of examples 1-11, above.

The permanent metallic joint further comprises a second support plate that is spaced apart from the support plate across a thickness of the first part and is made from the second metallic material. The first part further comprises a second tab comprising a second-tab first surface, a second-tab second surface, opposite the second-tab first surface, and a second-tab third surface, extending between the second-tab first surface and the second-tab second surface. The second support plate forms a butt joint with the second-tab second surface. The second part forms an intermetallic bond with the second-tab first surface and the second-tab third surface. The second part forms a metallurgical bond with the second support plate. The preceding subject matter of this paragraph characterizes example 13 of the present disclosure, wherein example 13 also includes the subject matter according to any of examples 1-12, above.

Further disclosed herein is an aircraft. The aircraft comprises a first part made from a first metallic material having a first melting temperature. The first part comprises a tab comprising a tab first surface, a tab second surface, opposite the tab first surface, and a tab third surface, extending between the tab first surface and the tab second surface. The aircraft also comprises a support plate forming a butt joint with the tab second surface. The support plate is made from a second metallic material having a second melting temperature less than the first melting temperature. The aircraft further comprises a second part made from a third metallic material having a third melting temperature less than the first melting temperature. The second part forms an intermetallic bond with the tab first surface and the tab third surface, and forms a metallurgical bond with the support plate. The preceding subject matter of this paragraph characterizes example 14 of the present disclosure.

Additionally disclosed herein is a method of making a permanent metallic joint between a first part and a second part. The method comprises making the first part. The method also comprises forming a butt joint between a support plate and a tab second surface of a tab of the first part. The method further comprises flowing a metallic material onto a tab first surface of the tab, a tab third surface of the tab, and the support plate so that the metallic material forms an intermetallic bond with the tab first surface and the tab third surface, and forms a metallurgical bond with the support plate. The tab first surface is opposite the tab second surface and the tab third surface extends between the tab first surface and the tab second surface. The method additionally comprises hardening the metallic material to make the second part. The preceding subject matter of this paragraph characterizes example 15 of the present disclosure.

Flowing the metallic material comprises flowing the metallic material into a casting mold comprising mold plates, at least a portion of the tab, and at least a portion of the support plate. The preceding subject matter of this paragraph characterizes example 16 of the present disclosure, wherein example 16 also includes the subject matter according to example 15, above.

Flowing the metallic material comprises depositing the metallic material, layer-by-layer, via an additive manufacturing machine. The preceding subject matter of this paragraph characterizes example 17 of the present disclosure, wherein example 17 also includes the subject matter according to any of examples 15-16, above.

The method further comprises fixing the first part and the support plate, when the support plate forms the butt joint with the tab second surface, so that the first part and the support plate are stationary, relative to each other, when the metallic material is flowed. The preceding subject matter of this paragraph characterizes example 18 of the present disclosure, wherein example 18 also includes the subject matter according to any of examples 15-17, above.

The first part is made of a second metallic material, having a second melting temperature. The metallic material flowed onto the tab first surface, the tab third surface, and the support plate has a first melting temperature. The second melting temperature is higher than the first melting temperature. The preceding subject matter of this paragraph characterizes example 19 of the present disclosure, wherein example 19 also includes the subject matter according to any of examples 15-18, above.

Flowing the metallic material onto the tab first surface, the tab third surface, and the support plate comprises encapsulating the tab between the metallic material and the support plate. The preceding subject matter of this paragraph characterizes example 20 of the present disclosure, wherein example 20 also includes the subject matter according to any of examples 15-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic, perspective view of an aircraft, according to one or more examples of the present disclosure;

FIG. 2 is a schematic, cross-sectional, perspective view of a permanent metallic joint, according to one or more examples of the present disclosure;

FIG. 3 is a schematic, cross-sectional, perspective view of a permanent metallic joint, according to one or more examples of the present disclosure;

FIG. 4A is a schematic, cross-sectional, side elevation view of a permanent metallic joint, according to one or more examples of the present disclosure;

FIG. 4B is a schematic, cross-sectional, side elevation view of a permanent metallic joint, according to one or more examples of the present disclosure;

FIG. 4C is a schematic, cross-sectional, side elevation view of a permanent metallic joint, according to one or more examples of the present disclosure;

FIG. 4D is a schematic, cross-sectional, side elevation view of a permanent metallic joint, according to one or more examples of the present disclosure;

FIG. 5 is a schematic, cross-sectional, side elevation view of a step of making a permanent metallic joint using a casting approach, according to one or more examples of the present disclosure;

FIG. 6 is a schematic, cross-sectional, side elevation view of another step of making a permanent metallic joint using a casting approach, according to one or more examples of the present disclosure;

FIG. 7 is a schematic, cross-sectional, side elevation view of yet another step of making a permanent metallic joint using a casting approach, according to one or more examples of the present disclosure;

FIG. 8 is a schematic, cross-sectional, side elevation view of a step of making a permanent metallic joint using an additive manufacturing approach, according to one or more examples of the present disclosure;

FIG. 9 is a schematic, cross-sectional, side elevation view of another step of making a permanent metallic joint using an additive manufacturing approach, according to one or more examples of the present disclosure;

FIG. 10 is a schematic, cross-sectional, side elevation view of yet another step of making a permanent metallic joint using an additive manufacturing approach, according to one or more examples of the present disclosure;

FIG. 11 is a schematic, cross-sectional, side elevation view of a permanent metallic joint, according to one or more examples of the present disclosure;

FIG. 12 is a schematic, cross-sectional, side elevation view of a permanent metallic joint, according to one or more examples of the present disclosure;

FIG. 13 is a schematic, cross-sectional, side elevation view of a permanent metallic joint, according to one or more examples of the present disclosure; and

FIG. 14 is a schematic flow chart of a method of making a permanent metallic joint, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

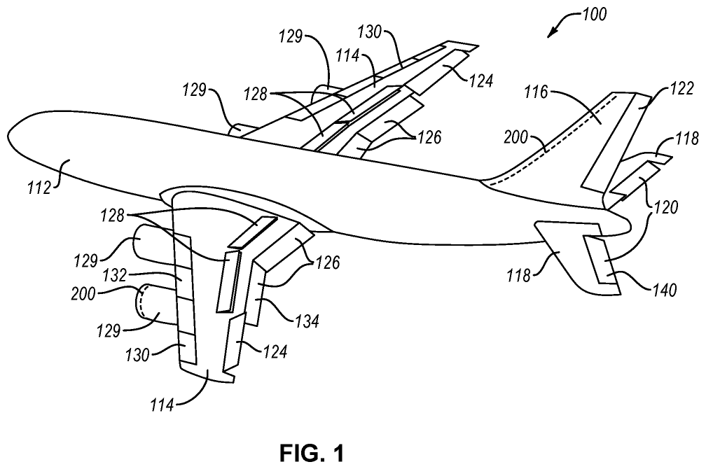

Referring to FIG. 1, one example of an aircraft 100 is shown. The aircraft 100 can be any of various types of aircraft, such as commercial aircraft used for the transportation of passengers, military aircraft for military operations, personal aircraft, and the like. As depicted, the aircraft 100 represents a passenger airplane. The depicted aircraft 100 includes a body 112 (e.g., fuselage), a pair of wings 114 coupled to and extending from the body 112, a vertical stabilizer 116 coupled to the body 112, and a pair of horizontal stabilizers 118 coupled to the body 112 and/or the vertical stabilizer 116. The aircraft 100 further includes a plurality of adjustable elements, which can be adjustable aerodynamic surfaces that are adjustable to change the characteristics of air flow over, around, and trailing the surfaces. For example, an aileron 124, flaps 126 (e.g., flap 134), spoilers 128, and slats 130 (e.g., slat 132) are coupled to each wing 114. Additionally, the vertical stabilizer 116 includes a rudder 122, and the horizontal stabilizers 118 include elevators 120 (e.g., elevator 140). For responsive control of the flight of the aircraft 100, the relative position of the adjustable aerodynamic surfaces of the aircraft, such as those shown in FIG. 1, should be capable of precise adjustment. The aircraft 100 also includes four wing-mounted external engines each covered by a respective one of multiple nacelles 129 of the aircraft 100.

As shown in FIG. 1, the aircraft 100 includes one or more permanent metallic joints 200. Each of the permanent metallic joints 200 joins together at least two parts of the aircraft 100. As defined herein, a permanent metallic joint 200 includes the interface between the at least two parts, as well as the at least two parts themselves. In one example, each one of the nacelles 129 of the aircraft 100 includes a permanent metallic joint 200 that joins together at least two parts of the nacelle 129, such as an inner shell and an outer shell of the nacelle 129. In some examples, the vertical stabilizer 116 includes a permanent metallic joint 200 that joins together at least two parts of the nacelle 129, such as a left side and a right side of the vertical stabilizer 116. It is recognized that the aircraft 100 can include any of various additional or alternative permanent metallic joints 200. Moreover, although the permanent metallic joint 200 is shown on an aircraft in FIG. 1, the permanent metallic joint 200 of the present disclosure can be used to assemble or couple together parts of any of various other vehicles, such as boats, automobiles, spacecraft, etc., or non-vehicle structures, such as containers, buildings, bridges, and the like.

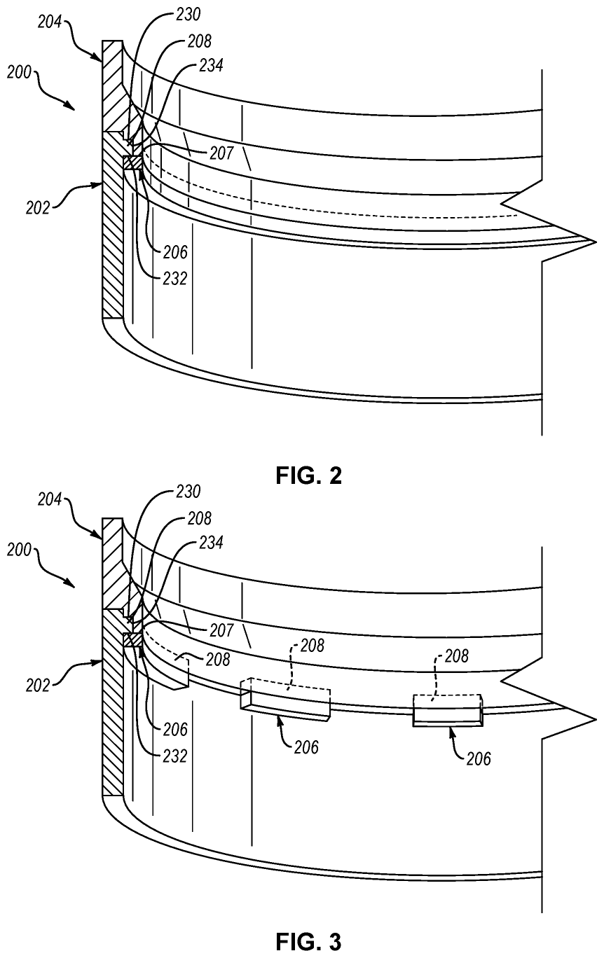

Referring to FIG. 2, according to one example, the permanent metallic joint 200 includes a first part 202, a support plate 206, and a second part 204. The first part 202 includes a tab 208. In some examples, the tab 208 can be any of various protrusions extending from a main body of the first part 202, such as a knob, stub, protrusion, or other cantilevered portion of the first part 202. The tab 208 has a tab first surface 230, a tab second surface 232, and a tab third surface 234. The tab first surface 230 is opposite the tab second surface 232. As defined herein, a surface of an object is opposite another surface of the object when the surfaces are on opposite sides of the object. In some examples, as shown, the tab first surface 230 is flat and the tab second surface 232 is flat. Additionally, as shown, in certain examples, the tab first surface 230 is parallel to the tab second surface 232, but can be non-parallel in other examples. In some examples, one or both of the tab first surface 230 and the tab second surface 232 is non-flat, curved, or undulated, while still being on opposite sides of the tab 208. The tab third surface 234 extends between the tab first surface 230 and the tab second surface 232. In other words, the tab third surface 234 couples together or connects the tab first surface 230 to the tab second surface 232. The tab third surface 234 defines the cantilevered end of the tab 208 and is offset from the main body of the first part 202 by the tab first surface 230 and the tab second surface 232. In the orientation depicted in FIGS. 2-4A, the tab first surface 230 is an upper surface of the tab 208, the tab second surface 232 is a lower surface of the tab 208, and the tab third surface 234 is a side surface of the tab 208.

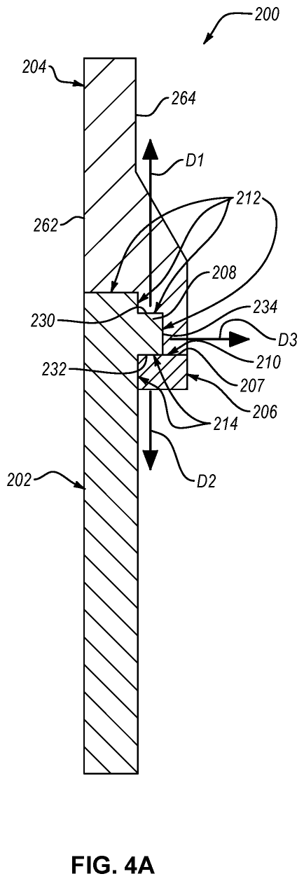

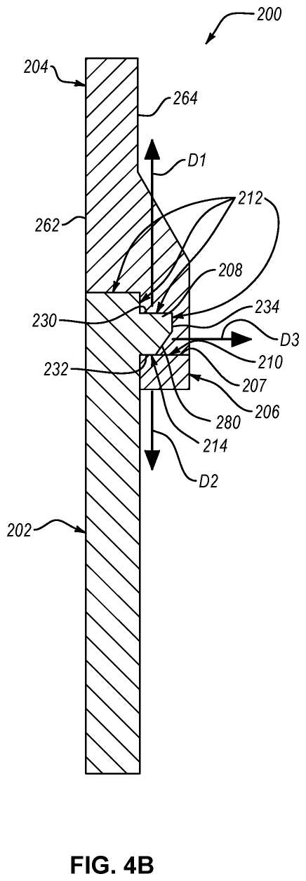

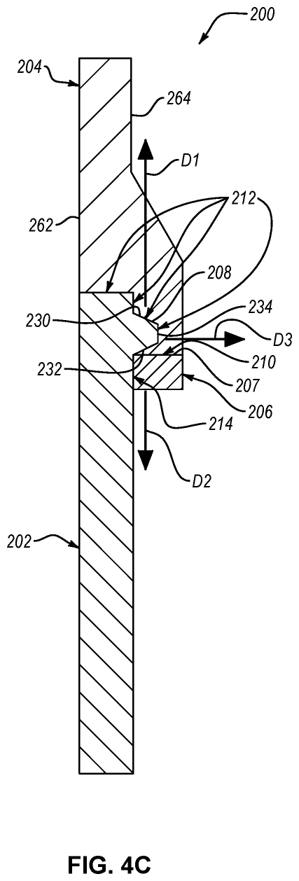

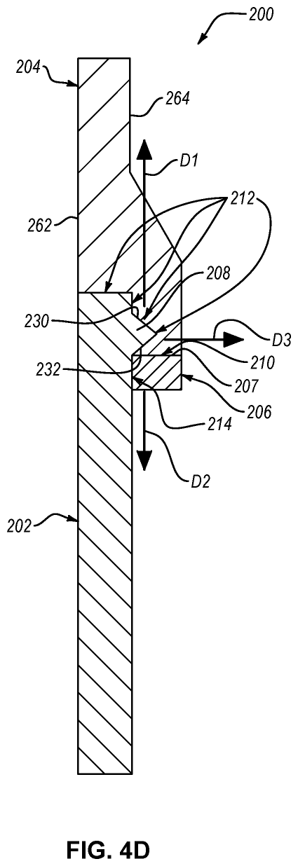

The support plate 206 forms a butt joint 214 (see, e.g., FIG. 4A) with the tab 208. More specifically, in some examples, the support plate 206 forms the butt joint 214 with the tab second surface 232 of the tab 208. The surface of the support plate 206 forming the butt joint 214 with the tab 208 can be defined as an interface surface 207 of the support plate 206. An exposed portion of the interface surface 207 extends or protrudes beyond the tab second surface 232 so that the exposed portion can receive the metallic material of the second part 204. In some examples, the support plate 206 also forms a butt joint with a portion of the first part 202 directly adjacent to the tab 208 to provide additional retention of the first part 202 relative to the second part 204.

As shown in FIG. 2, in some examples, the tab 208 of the first part 202 and/or the support plate 206 are continuous such that the tab 208 and the support plate 206 continuously extend along an entirety of the permanent metallic joint 200. In one example, as shown in FIG. 3, both the tab 208 and the support plate 206 continuously extend along an entirety of the permanent metallic joint 200. However, in other examples, only one of the tab 208 or the support plate 206 continuously extends along an entirety of the permanent metallic joint 200.

Referring to FIG. 3, according to certain examples, the tab 208 of the first part 202 and/or the support plate 206 are not continuous such that the first part 202 effectively includes a plurality of tabs 208 that are spaced apart from each other, and/or a plurality of support plates 206 that are spaced apart from each other. In one example, as shown in FIG. 3, the first part 202 includes a plurality of tabs 208 spaced apart along a length of the first part 202, and a plurality of support plates 206 spaced apart the length of the first part 202. Each one of the plurality of tabs 208 forms a butt joint with the tab second surface 232 of a corresponding one of the plurality of tabs 208. In other words, the plurality of tabs 208 are aligned with the plurality of support plates 206. In contrast to FIG. 3, in certain examples, either the first part 202 includes a plurality of tabs 208 or the permanent metallic joint 200 includes a plurality of support plates 206.

The second part 204 is coupled in intimate contact with at least the tab 208 of the the first part 202 and the support plate 206. In some examples, the intimate contact between the second part 204 and the first part 202 is such that an interface between the second part 204 and the first part 202 is gapless. When coupling together two, fully formed and hardened parts (e.g., via fasteners), gaps are inherently present along the interface between the parts due to the irregularities or surface roughness of the mating surfaces of parts. However, as will be explained in more detail below, because the second part 204 is formed onto the first part 202, the second part 204 is not fully formed and hardened when mated with the first part 202. Rather, the metallic material of the second part 204, being flowable when deposited onto the first part 202, fills irregularities in the surfaces of the first part 202, which promotes a gapless interface between the first part 202 and the second part 204.

The formation of the permanent metallic joint 200 in the above-mentioned manner creates bonds between the first part 202 and the second part 204, and between the second part 204 and the support plate 206. As shown in FIG. 4A, intermetallic bonds 212 are formed between the mating surfaces of the first part 202 and the second part 204. In contrast, a metallurgical bond 210 is formed between the mating surfaces of the second part 204 and the support plate 206. The intermetallic bond 212 may be weaker than the metallurgical bond 210. As defined herein, an intermetallic bond is a bond between two or more unlike metal alloys where electropositive and electronegative elements of the metallic parts chemically interact superficially creating metal that is a combination of the alloys. Also, as defined herein, a metallurgical bond is a bond between metallic parts where the metallic materials of the parts diffuse together and form deep intermolecular attractions.

The first part 202 is made from a first metallic material that has a first melting temperature. In some example, the first metallic material of the first part 202 is selected to withstand extremely high operating temperatures associated with the application of the first part 202. The support plate 206 is made from a second metallic material that has a second melting temperature. The second melting temperature of the second metallic material of the support plate 206 is less than the first melting temperature of the first metallic material of the first part 202. The second part 204 is made from a third metallic material that has a third melting temperature. The third melting temperature of the third metallic material of the second part 204 is less than the first melting temperature of the first metallic material of the first part 202. In some examples, the second melting temperature of the second metallic material is the same as or similar to the third melting temperature of the third metallic material. For example, the second metallic material can be the same type of material as the third metallic material (e.g., the second metallic material can be a first titanium alloy and the third metallic material can be a second titanium alloy, having the same or a higher melting temperature than the first titanium alloy). However, both the second metallic material and the third metallic material are a different type of material than the first metallic material. In some examples, the titanium alloys of the present disclosure can be one or more of Ti 6Al-4V, Ti 6Al-2Sn-4Zr-2Mo, Ti 5Al-5Mo-5V-3Cr, Ti 7-4-3, and the like.

According to certain examples, the third metallic material is selected so that the third melting temperature is sufficiently lower than the first metallic material, so that depositing (e.g., flowing) the third metallic material of the second part 204 onto the first metallic material of the first part 202 does not deform the second part 204, and sufficiently high, so that the second part 204 can withstand operating temperatures to be encountered during operation. In one example, a ratio of the third melting temperature to the first melting temperature is between, and inclusive of, 79 and 83 (e.g., Ti 6-4 alloy to Inco 718™ (nickel alloy)). According to another example, the ratio of the third melting temperature to the first melting temperature is between, and inclusive of, 68 and 70 (e.g., Ti 6-4 alloy to niobium-hafnium alloy). In yet another example, the ratio of the third melting temperature to the first melting temperature is between, and inclusive of, 48 and 51 (e.g., nickel alloy to niobium-tungsten alloy). According to one example, the third metallic material of the second part 204 is a nickel alloy and the first metallic material of the first part 202 is niobium-hafnium. In another example, the third metallic material of the second part 204 is titanium or a titanium alloy, and the first metallic material of the first part 202 is a niobium-tungsten alloy. According to yet another example, the third metallic material of the second part 204 is a titanium alloy and the first metallic material of the first part 202 is a nickel alloy. In some examples, the nickel alloys of the present disclosure can be one or more of Inco 718™, Inco 625™, Rene 41™, Waspaloy™, and the like. In yet some examples, the niobium alloys of the present disclosure can have one or more of the following alloying elements, including hafnium, tungsten, titanium, zirconium, molybdenum, and the like. In some examples, one or more of the metallic materials of the present disclosure can be made of a cobalt alloy, such as L-605.

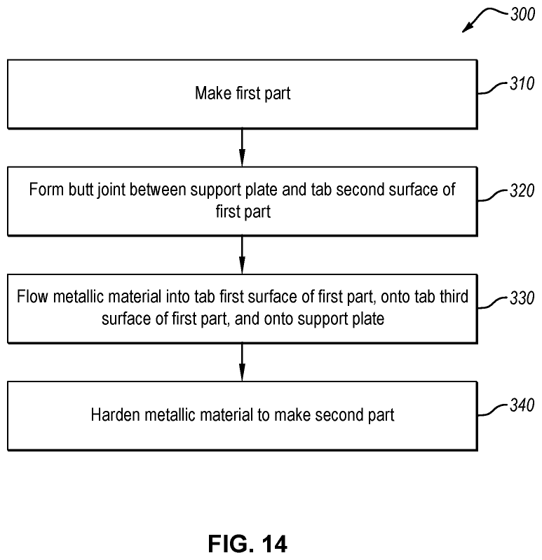

Referring to FIG. 14, according to some examples, a method (300) of making the permanent metallic joint 200 includes (block 310) making the first part 202. The first part 202 can be made using any of various techniques, such as machining, casting, molding, etc. Moreover, in some examples, the first part 202 is made to have a one-piece unitary single construction. In another example, the first part 202 is a separable or inseparable assembly of parts. In certain examples, the first part 202 is made when the first part 202 is in a final state or a production-ready state such that no further changes to the first part 202 are necessary. In those examples where the first part 202 is made from a material in a flowable or non-hardened state, the first part 202 can be considered made only after the first part 202 is hardened or cured.

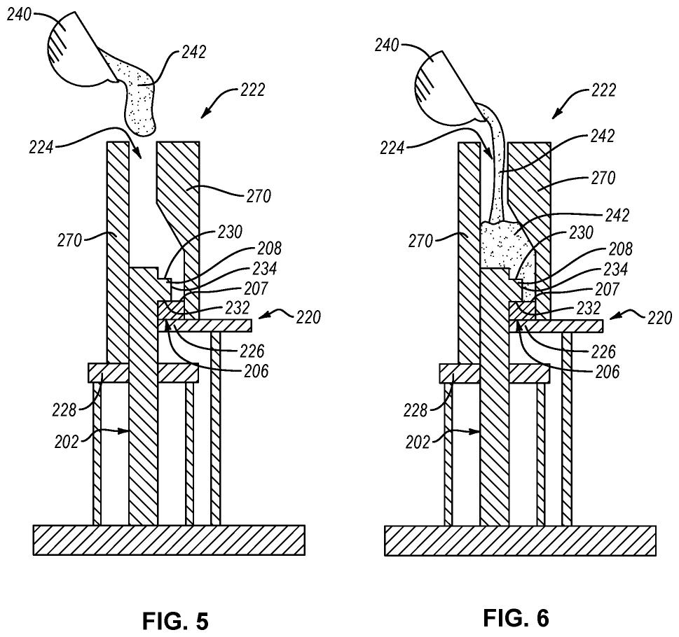

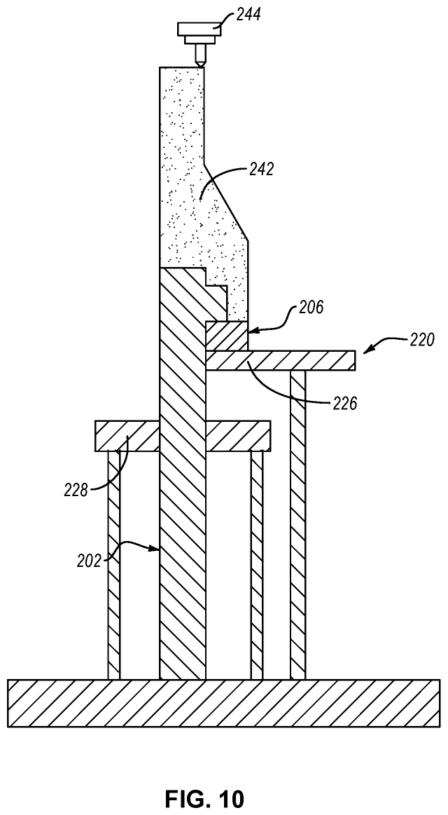

The method 300 also includes (block 320) forming the butt joint 214 between the support plate 206 and the tab second surface 232 of the tab 208. In some examples, the support plate 206 is positioned in contact with the tab second surface 232 to form the butt joint 214. Referring to FIGS. 5-10, in certain examples, the formation of the butt joint 214 is facilitated by a support tool 220. The support tool 220 provides a stable foundation and part retention mechanism that promotes proper position and retention of the first part 202 and the support plate 206 while the second part 204 is formed. As shown, the support tool 220 includes a first-part retention portion 228 and a support-plate retention portion 226. Both the first-part retention portion 228 and the support-plate retention portion 226 can be anchored to and extend from a stand or footing. In one example, the first-part retention portion 228 includes an aperture that retains a main body of the first part 202. In the same example, the support-plate retention portion 226 is vertically offset above the first-part retention portion 228 and includes a support surface that supports the support plate 206 in a position against the tab second surface 232, thus helping to maintain the butt joint 214 between the support plate 206 and the tab second surface 232.

The method 300 additionally includes (block 330) flowing the third metallic material of the second part 204 onto the tab first surface 230 of the tab 208, onto the tab third surface 234 of the tab 208, and onto the support plate 206. In other words, when in a flowable state, the third metallic material is deposited onto the tab first surface 230, onto the tab third surface 234, and onto the exposed portion of the interface surface 207 of the support plate 206. Because of the differences in the types of materials, between the first metallic material of the first part 202 and the third metallic material of the second part 204 (e.g., different melting temperatures), when the third metallic material flows onto the first part 202, only minimal, weak, bonding (e.g., intermetallic bonding) occurs between the third metallic material and the first metallic material. However, because of the similarities, in the types of materials, between the second metallic material of the support plate 206 and the third metallic material of the second part 204, significant and strong bonding (e.g., metallurgical bonding) occurs between the second metallic material and the third metallic material.

The method 300 additionally includes (block 340) hardening the metallic material to make the second part 204. After flowing the third metallic material onto the first part 202 and the support plate 206, the molten or flowable material is allowed to harden, which permanently sets the metallurgical bonding between the second part 204 and the support plate 206. Hardening of the third metallic material, to form the second part 204, can be facilitated by passive or forced air or other gas drying of the second part 204. After the third metallic material is hardened and the second part 204 is formed onto the first part 202, the permanent metallic joint 200 is made and can be removed from the support tool 220 for further processing and/or assembly.

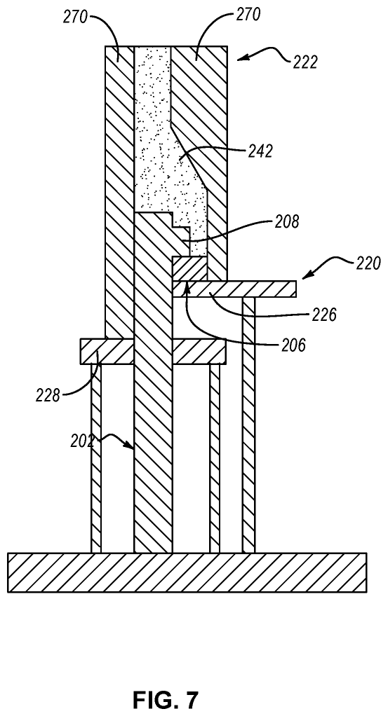

Referring to FIGS. 5-7, in some examples, the second part 204 is a cast part formed via a casting technique. The casting technique utilizes a casting mold 222, which can be incorporated into the support tool 220. The casting mold 222 includes mold portions 270, which, in combination with exposed surfaces of the first part 202 and the support plate 206, define a mold cavity 224 having a shape corresponding with the desired shape of the second part 204 (see, e.g., FIG. 5). The mold portions 270 can be integrated into or coupled to the first-part retention portion 228 and/or the support-plate retention portion 226 of the support tool 220. Referring to FIG. 5, a container 240 containing a third metallic material 242, in a molten state, is tipped or opened to enable the third metallic material 242 to flow into the mold cavity 224. The mold cavity 224 is filled (see, e.g., FIG. 6) until the third metallic material 242 fills a desired portion of the mold cavity 224 and assumes the desired shape of the second part 204 (see, e.g., FIG. 7). After the third metallic material 242 within the mold cavity 224 has sufficiently hardened, the mold portions 270 can be removed, which enables removal of the permanent metallic joint 200 from the support tool.

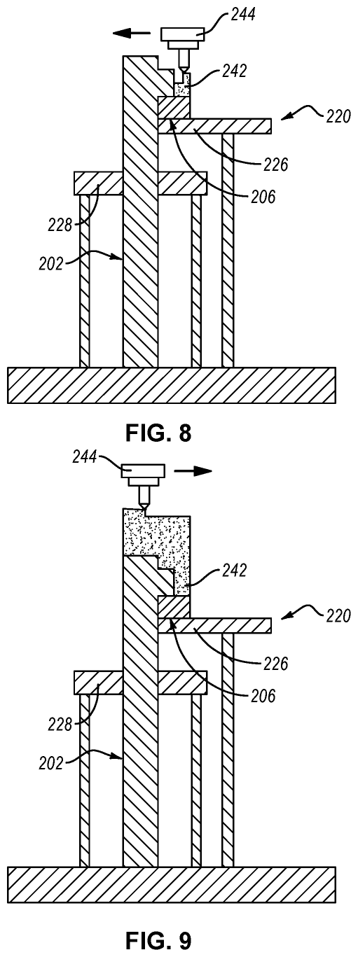

Referring to FIGS. 8-10, in some examples, the second part 204 is an additively manufactured part formed via an additive manufacturing technique. The additive manufacturing technique utilizes an additive manufacturing machine 244 to deposit the third metallic material 242, in a molten or flowable state, onto the first part 202 and the support plate 206. The additive manufacturing machine 244 can be any of various types of additive manufacturing machines known in the art. In some example, the additive manufacturing machine 244 includes a nozzle from which the third metallic material 242 flows as a continuous bead. As the third metallic material 242 flows from the nozzle, the nozzle is movable horizontally, as shown by directional arrows in FIGS. 8 and 9, to deposit a layer of the third metallic material 242. The nozzle can then be moved vertically to deposit an additional layer onto the previously deposited layer. In this manner, the second part 204 can be built up, layer-by-layer. After the third metallic material 242 hardens, the permanent metallic joint 200 can be removed from the support tool 220.

Referring to FIG. 4A, after the third metallic material 242 is flowed onto the first part 202 and the support plate 206, and allowed to harden, such that a permanent metallurgical bond is formed between the second part 204 and the support plate 206, the tab 208 is effectively encapsulated between the second part 204 and the support plate 206. In other words, the tab 208 is secured, bound, or otherwise retained between the second part 204 and the support plate 206 via the strength of the metallurgical bond between the second part 204 and the support plate 206. The encapsulation of the tab 208 by the second part 204 and the support plate 206 helps prevent movement of the first part 202 relative to the second part 204 in multiple directions. For example, engagement between the second part 204 and the tab first surface 230 prevents the first part 202 from movement in a first direction D1 relative to the second part 204. Similarly, engagement between the second part 204 and the tab second surface 232 prevents the first part 202 from movement in a second direction D2 relative to the second part 204, where the second direction D2 is opposite the first direction D1. Also, engagement between the second part 204 and the tab third surface 234 prevents the first part 202 from movement in a third direction D3 relative to the second part 204. The third direction D3 is perpendicular to the first direction D1 and the second direction D2. The encapsulation of the tab 208 by the second part 204 and the support plate 206 is sufficient keep the permanent metallic joint 200 together. Accordingly, the permanent metallic joint 200 does not need fasteners or adhesives, and in fact is void of or free of fastener and adhesives, which promotes ease in manufacturing because a user need not keep track of small fasteners and deal with messy adhesives.

Referring to FIGS. 4B-4D, various alternative examples of the tab 208 are shown. In the example of FIG. 4B, the tab 208 includes a chamfer 280 extending between the tab second surface 232 and the tab third surface 234. The chamfer 280 promotes underfill of the third metallic material 242 of the second part 204 below the tab 208 so that the area of the surface of the support plate 206 metallurgically bonded to the second part 204 is increased, which helps to reduce bending of the support plate 206 under stress. In the example of FIG. 4C, the tab first surface 230 and the tab second surface 232 are angled relative to each other and converge towards the tab third surface 234 in the third direction D3. Accordingly, the tab 208 in FIG. 4C has a frusto-conical cross-sectional shape. Like the example of FIG. 4B, the example of FIG. 4C increases the area of the surface of the support plate 206 that is metallurgically bonded to the second part 204. Finally, in the example of FIG. 4D, the tab third surface 234 is removed and the tab first surface 230 and the tab second surface 232 converge to a point. Accordingly, the tab 208 in FIG. 4D has a triangular cross-sectional shape, a conical cross-sectional shape, or any of various other cross-sectional shapes.

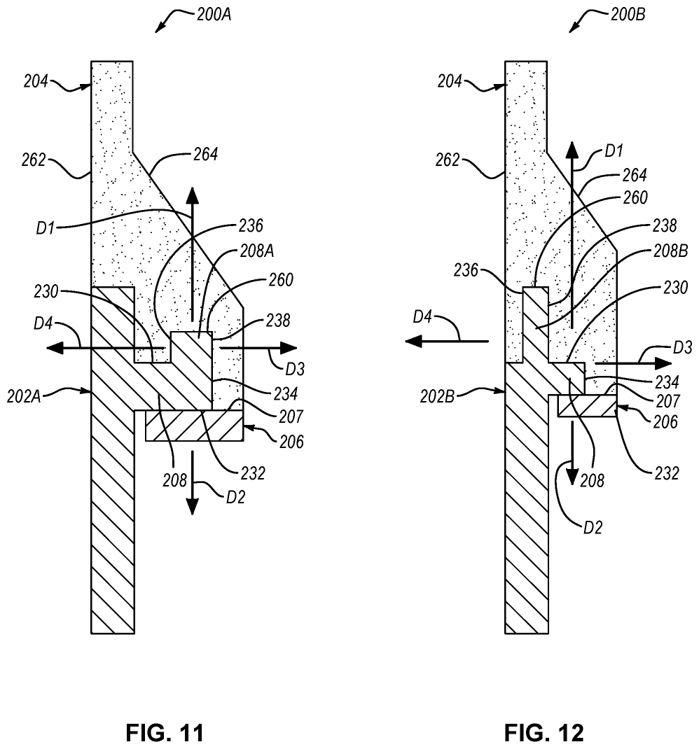

To help prevent movement of the first part 202 relative to the second part 204, in a fourth direction D4 that is opposite the third direction D4, the first part 202 further includes a second tab. Referring to FIG. 11, a permanent metallic joint 200A includes features analogous to the features of the permanent metallic joint 200, with like numbers referring to like features. For example, the first part 202A of the permanent metallic joint 200A includes a tab 208 (e.g., a first tab). However, unlike the first part 202, the first part 202A also includes a second tab 208A. The second tab 208A protrudes from the tab 208 in a direction angled (e.g., perpendicular, acutely angled, or obtusely angled, etc.) relative to the protrusion direction of the tab 208. In the orientation of the permanent metallic joint 200A shown in FIG. 11, the tab 208 protrudes in a left-to-right direction and the second tab 208A protrudes from the tab 208 in a bottom-to-top direction. Like the tab 208, the second tab 208A includes three major surfaces. For example, the second tab 208A includes a second-tab first surface 236, a second-tab second surface 238, and a second-tab third surface 260. The second-tab first surface 236 is on an opposite side of the second tab 208A than the second-tab second surface 238. Also, the second-tab third surface 260 extends between the second-tab first surface 236 and the second-tab second surface 238. In some examples, the second-tab first surface 236 is parallel to the second-tab second surface 238, and the second-tab third surface 260 is perpendicular to the second-tab first surface 236 and the second-tab second surface 238. Engagement between the second part 204 and the second-tab first surface 236 prevents the first part 202A from movement in the fourth direction D4 relative to the second part 204.

Referring to FIG. 12, according to another example, a permanent metallic joint 200B similar to the permanent metallic joint 200A is shown. However, the shape of the first part 202B and the position of the second tab 208B on the first part 202B is different than the shape of the first part 202A and the position of the second tab 208A on the first part 202A. While the first part 202A has a portion interposed between the second tab 208A and an exterior surface 262 (which is opposite an interior surface 264) of the permanent metallic joint 200A in the fourth direction D4, no portion of the first part 202B is between the second tab 208B and the exterior surface 262 of the permanent metallic joint 200B in the fourth direction D4. Also, the second tab 208A is located at the tab third surface 234, such that the second-tab second surface 238 is contiguous (e.g., co-planar) with the tab third surface 234. In contrast, the second tab 208B is offset from the tab third surface 234 in the fourth direction D4.

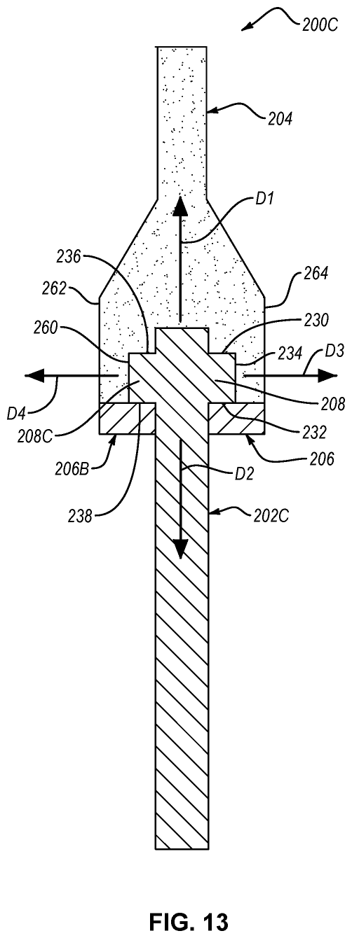

The permanent metallic joint 200, the permanent metallic joint 200A, and the permanent metallic joint 200B are considered a one-sided joint because the support plate 206 is located on only one side of the first part 202, the first part 202A, and the first part 202B, respectively. However, in other examples, such as shown in FIG. 13, a permanent metallic joint 200C can be two-sided. The permanent metallic joint 200C has a support plate 206 on one side of the first part 202C and a second support plate 206B on an opposite side of the first part 202C. The first part 202C includes a second tab 208C, which has a second-tab first surface 236, a second-tab second surface 238, and a second-tab third surface 260. The second tab 208C is on an opposite side of the first part 202C than the tab 208. In some examples, the second tab 208C is a mirror image of the tab 208. Moreover, the second-tab second surface 238 of the second tab 208C forms a butt joint with the second support plate 206B and the second part 204 forms a metallurgical bond with the second support plate 206B. Like the one-sided joints, the two sided joint of FIG. 13 helps prevent movement of the first part 202C relative to the second part 204 in the first direction D1, the second direction D2, the third direction D3, and the fourth direction D4.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A permanent metallic joint, comprising:
a first part made from a first metallic material having a first melting temperature, wherein the first part comprises a tab comprising a tab first surface and a tab second surface, opposite the tab first surface;
a support plate forming a butt joint with the tab, wherein the support plate is made from a second metallic material having a second melting temperature less than the first melting temperature; and
a second part made from a third metallic material having a third melting temperature less than the first melting temperature, wherein the second part forms an intermetallic bond with the tab first surface, and forms a metallurgical bond with the support plate.

2. The permanent metallic joint according to claim 1, wherein one of:
the tab further comprises a tab third surface and a chamfer, the tab third surface extends from the tab first surface to the chamfer, and the chamfer extends between the tab third surface and the tab second surface; or
the tab first surface and the tab second surface converge toward each other.

3. The permanent metallic joint according to claim 1, wherein the second part is in intimate contact with the first part such that an interface between the first part and the second part is gapless.

4. The permanent metallic joint according to claim 1, wherein the second part is a cast part.

5. The permanent metallic joint according to claim 1, wherein the second part is an additively manufactured part.

6. The permanent metallic joint according to claim 1, wherein:
the first metallic material and the third metallic material are different types of metallic material; and
the second metallic material and the third metallic material are a same type or similar types of metallic material.

7. The permanent metallic joint according to claim 1, wherein the permanent metallic joint is free of fasteners and adhesives.

8. The permanent metallic joint according to claim 1, wherein:
the first part comprises a plurality of tabs spaced apart from each other along a length of the first part;
the permanent metallic joint comprises a plurality of support plates spaced apart from each other along a length of the first part;
each one of the plurality of support plates forms a butt joint with a corresponding one of the plurality of tabs;
the second part forms an intermetallic bond with the tab first surface and a tab third surface, extending between the tab first surface and the tab second surface, of each one of the plurality of tabs; and
the second part forms a metallurgical bond with each one of the plurality of support plates.

9. The permanent metallic joint according to claim 1, wherein the permanent metallic joint:
prevents movement of the first part relative to the second part in a first direction, a second direction, opposite the first direction, and a third direction, perpendicular to the first direction and the second direction; and
enables movement of the first part relative to the second part in a fourth direction opposite the third direction.

10. The permanent metallic joint according to claim 1, wherein:
the first part further comprises a second tab comprising a second-tab first surface and a second-tab second surface, opposite the second-tab first surface; and
the second part forms an intermetallic bond with the second-tab first surface and the second-tab second surface.

11. The permanent metallic joint according to claim 10, wherein the permanent metallic joint prevents movement of the first part relative to the second part in a first direction, a second direction, opposite the first direction, a third direction, perpendicular to the first direction and the second direction, and a fourth direction, opposite the third direction.

12. The permanent metallic joint according to claim 1, wherein:
the tab further comprises a tab third surface that is perpendicular to the tab first surface and the tab second surface, and extends between the tab first surface and the tab second surface; and
the tab first surface is parallel to the tab second surface.

13. The permanent metallic joint according to claim 1, further comprising a second support plate that is spaced apart from the support plate across a thickness of the first part and is made from the second metallic material, wherein:
the first part further comprises a second tab comprising a second-tab first surface, a second-tab second surface, opposite the second-tab first surface, and a second-tab third surface, extending between the second-tab first surface and the second-tab second surface;
the second support plate forms a butt joint with the second-tab second surface;
the second part forms an intermetallic bond with the second-tab first surface and the second-tab third surface; and
the second part forms a metallurgical bond with the second support plate.

14. An aircraft comprising:
a first part made from a first metallic material having a first melting temperature, wherein the first part comprises a tab comprising a tab first surface, a tab second surface, opposite the tab first surface, and a tab third surface, extending between the tab first surface and the tab second surface;
a support plate forming a butt joint with the tab second surface, wherein the support plate is made from a second metallic material having a second melting temperature less than the first melting temperature; and
a second part made from a third metallic material having a third melting temperature less than the first melting temperature, wherein the second part forms an intermetallic bond with the tab first surface and the tab third surface, and forms a metallurgical bond with the support plate.

15. A method of making a permanent metallic joint between a first part and a second part, the method comprising:
making the first part;
forming a butt joint between a support plate and a tab second surface of a tab of the first part;
flowing a metallic material onto a tab first surface of the tab, a tab third surface of the tab, and the support plate so that the metallic material forms an intermetallic bond with the tab first surface and the tab third surface, and forms a metallurgical bond with the support plate, wherein the tab first surface is opposite the tab second surface and the tab third surface extends between the tab first surface and the tab second surface; and
hardening the metallic material to make the second part.

16. The method according to claim 15, wherein flowing the metallic material comprises flowing the metallic material into a casting mold comprising mold plates, at least a portion of the tab, and at least a portion of the support plate.

17. The method according to claim 15, wherein flowing the metallic material comprises depositing the metallic material, layer-by-layer, via an additive manufacturing machine.

18. The method according to claim 15, further comprising fixing the first part and the support plate, when the support plate forms the butt joint with the tab second surface, so that the first part and the support plate are stationary, relative to each other, when the metallic material is flowed.

19. The method according to claim 15, wherein:
the first part is made of a second metallic material, having a second melting temperature;
the metallic material flowed onto the tab first surface, the tab third surface, and the support plate has a first melting temperature; and
the second melting temperature is higher than the first melting temperature.

20. The method according to claim 15, wherein flowing the metallic material onto the tab first surface, the tab third surface, and the support plate comprises encapsulating the tab between the metallic material and the support plate.
